(19) United States
(12) Patent Application Publication
(10) Pub. No.: US 2025/0322275 A1
(43) Pub. Date: Oct. 16, 2025

(54) TOKEN SELECTION IN TRANSFORMER NEURAL NETWORKS FOR EFFICIENT INFERENCING

(71) Applicant: QUALCOMM Incorporated, San Diego, CA (US)

(72) Inventors: Manish Kumar SINGH, San Diego, CA (US); Hong CAI, San Diego, CA (US); Mingu LEE, San Diego, CA (US); Fatih Murat PORIKLI, San Diego, CA (US)

(21) Appl. No.: 18/821,896

(22) Filed: Aug. 30, 2024

Related U.S. Application Data
(60) Provisional application No. 63/633,786, filed on Apr. 14, 2024.

(51) Int. Cl. G06N 5/04; G06N 3/0464

(52) U.S. Cl. CPC G06N 5/04; G06N 3/0464

(57) ABSTRACT

Certain aspects of the present disclosure provide techniques and apparatus for processing data using a transformer neural network. The method generally includes generating, via a first attention layer of a machine learning model, a first attention map based on an input into the machine learning model; identifying, using a token prediction model, a first subset of tokens in the first attention map more relevant to a second attention layer of the machine learning model and a second subset of tokens in the first attention map less relevant to the second attention layer of the machine learning model; generating, via the second attention layer of the machine learning model, a second attention map based on the first subset of tokens in the first attention map; and generating an inference based on the second attention map and the second subset of tokens in the first attention map.

### CROSS-REFERENCE TO RELATED APPLICATION

This application claims priority to U.S. Patent Application No. 63/633,786, filed Apr. 14, 2024, which is hereby incorporated by reference herein.

### INTRODUCTION

Aspects of the present disclosure relate to neural networks, and more specifically, to efficient execution of inferencing operations using neural networks.

Machine learning models, such as convolutional neural networks, transformer neural networks, and the like, are used for various tasks, such as object detection in visual content, segmentation of visual content, processing data having objects with different dimensions, generating natural language responses to natural language queries, and the like. In order to perform these tasks, these machine learning models may be trained to perform various operations internally (e.g., to map input data into representations in a latent space based on which an inference can be performed, to project inputs into tokens (e.g., key, query, and value tokens in a transformer neural network), apply an activation function to data generated by the machine learning model, etc.). These operations may vary in complexity, from relatively simple mathematical operations (e.g., addition, multiplication, etc.) to complex mathematical operations that involve significant amounts of processor time and memory utilization.

### BRIEF SUMMARY

Certain aspects of the present disclosure provide a processor-implemented method for efficient inferencing using a machine learning model. The method generally includes generating, via a first attention layer of a machine learning model, a first attention map based on an input into the machine learning model; identifying, using a token prediction model, a first subset of tokens in the first attention map more relevant to a second attention layer of the machine learning model and a second subset of tokens in the first attention map less relevant to the second attention layer of the machine learning model; generating, via the second attention layer of the machine learning model, a second attention map based on the first subset of tokens in the first attention map; and generating an inference based on the second attention map and the second subset of tokens in the first attention map.

Certain aspects of the present disclosure provide a processor-implemented method for training a predictive model for efficient inferencing. The method generally includes generating a plurality of ground-truth attention maps for a set of inputs in a training data set using a machine learning model; training a token prediction model to generate a predicted attention map based on the training data set, wherein the token prediction model is trained based on minimizing a difference between the predicted attention map and a corresponding ground-truth attention map from the plurality of ground-truth attention maps, and wherein the predicted attention map includes a plurality of tokens, each respective token being associated with a respective relevance score generated based on the predicted attention map; and deploying the token prediction model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example transformer neural network architecture.

FIG. 2 illustrates an example transformer neural network including layers that selectively process tokens generated by a previous layer in the transformer neural network, according to aspects of the present disclosure.

FIG. 3 illustrates a pipeline for efficiently performing inferencing operations in a transformer neural network based on token selection using a predictive model, according to aspects of the present disclosure.

FIG. 4 illustrates a pipeline for training a predictive model to select tokens for selective processing in a transformer neural network, according to aspects of the present disclosure.

FIG. 5 illustrates example operations for efficiently performing inferencing operations in a transformer neural network based on token selection, according to aspects of the present disclosure.

FIG. 6 illustrates example operations for training a predictive model to select tokens for selective processing in a transformer neural network, according to aspects of the present disclosure.

FIG. 7 depicts an example processing system configured to perform various aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for efficiently performing inferencing operations using transformer neural networks.

Various types of neural networks can be used to generate inferences based on input data (e.g., detect objects, predict future motion of objects detected in visual content, segment visual content into different semantic groups, etc.), such as still images or streams of visual content (e.g., video content captured as a series of images at a given frame rate, such as 24 frames per second, 29.97 frames per second, 60 frames per second, etc.). However, these neural networks generally process visual content on a per-frame basis, which may be a computationally expensive process that increases in complexity as the frame size of each frame in the visual content increases.

Transformer neural networks (also referred to as “transformers”), and in particular vision transformers, have become increasingly common in a wide variety of machine learning tasks. Transformer-based architectures are generally configured to generate output based on a sequence of data (e.g., a sequence of frames in a video, a sequence of patches from a frame or image, and the like). Generally, machine learning models may use any number of transformer blocks (each providing self-attention), as well as any other components (e.g., one or more neural network layers).

Generating inferences using a transformer neural network may be a computationally expensive process due to the structure of these networks. Generally, an input may be projected into a plurality of tokens for processing within the transformer neural network, and each attention layer within the transformer neural network can perform operations on each token in order to generate a feature map of tokens ingested by a subsequent layer for processing. While processing each token associated with an input into the transformer neural network may allow for accurate inferencing, doing so may be computationally inefficient due the relative importance of different tokens generated by a layer of the transformer neural network. That is, for a set of tokens generated by the i^{th} layer of a transformer neural network, a subset of tokens may be relevant for the generation of a set of tokens by the i+1^{th} layer of the transformer neural network. However, because each layer of the transformer neural network is generally configured to process each token input into that layer regardless of the relevance of such a token to inferencing operations performed by that layer of the neural network, computing resources may be wasted on processing tokens that are less likely to be relevant to a task for which the transformer neural network is used. In examples in which a transformer neural network is used to identify and predict the motion of objects in a scene captured in visual content, tokens associated with static content (e.g., background data, non-mobile objects, etc.) may be processed even though these objects are unlikely to be relevant to the detection of objects in motion and the predicted pattern of such motion.

Aspects of the present disclosure provide techniques for reducing the computational cost of processing input data in transformer neural networks. As discussed in further detail herein, to reduce the computational expense involved in inferencing operations using a transformer neural network, a predictive model may be used to predict a subset of tokens generated by an i^{th} layer in the transformer neural network which are likely to be relevant to operations performed by an i+1^{th} layer in the transformer neural network. The predicted subset of tokens may be provided as an input to the i+1^{th} layer of the transformer neural network, and tokens generated by the i^{th} layer other than the predicted subset of tokens may be omitted from an input into the i+1^{th} layer of the transformer neural network. The i+1^{th} layer of the transformer neural network may subsequently generate an output with a reduced size relative to the output of the i^{th} layer of the transformer neural network, and this output may be combined with the tokens generated by the i^{th} layer other than the predicted subset of tokens to generate an input for the i+2^{th} layer of the transformer neural network that retains the size of the input into the i^{th} layer of the transformer neural network. Thus, fewer compute resources may be utilized to complete various tasks for which transformer neural networks are used, such as object detection or other computer vision tasks, while maintaining or improving inferencing accuracy relative to techniques in which tokens are naively processed by each layer of a transformer neural network without using the token selection techniques described herein. In turn, the techniques discussed herein may reduce the amount of power used by computing devices to perform these tasks and/or accelerate processing of multidimensional inputs, relative to the amount of power and/or time used when outliers are not attenuated in a transformer neural network.

### Example Transformer Architecture

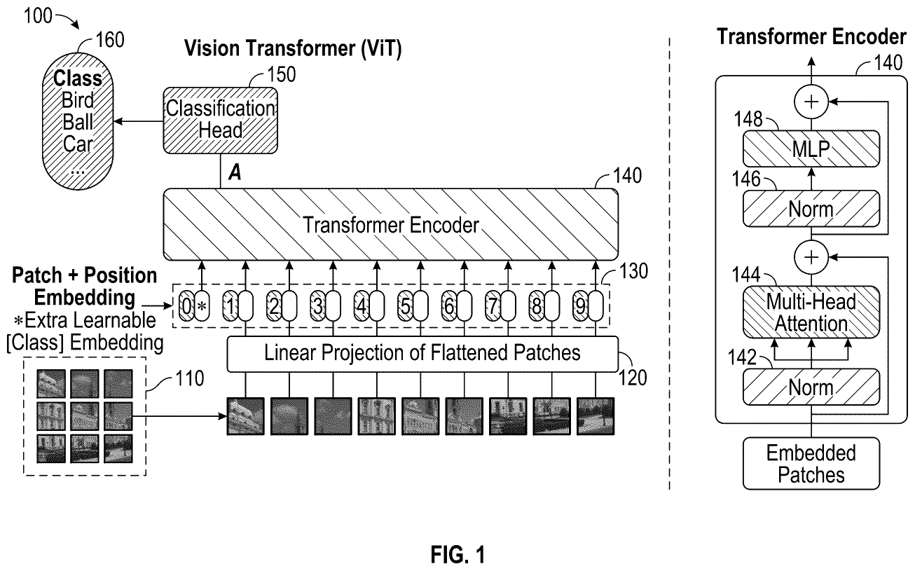

FIG. 1 illustrates an example vision transformer neural network 100 in which attention data is propagated through a transformer encoder block in the neural network (e.g., for other transformer block(s) in the network) in order to generate an output of the neural network.

As illustrated in FIG. 1, an input data sample 110 is accessed by a transformer encoder 140 (which is an example of a transformer block). As used herein, accessing data can generally include receiving, retrieving, requesting, or otherwise gaining access to the data. As discussed above, the input data sample 110 may correspond to the input (e.g., raw or preprocessed input data) to the first transformer block of a model, the output of a prior transformer or other model component or block, or the like. For example, the input data sample 110 may correspond to a multidimensional input, a tokenized version of the multidimensional input (which may optionally include positional embedding(s) and/or learnable token(s)), or the like. The tokenized version of the multidimensional input may also be referred to as a set of features for the multidimensional input generated over different portions of the multidimensional input (e.g., different spatial portions, or patches, of the multidimensional input across multiple points in time).

For visual data, as illustrated, the input data sample 110 may be split into a plurality of patches (e.g., portions of the visual data). The plurality of patches may have the same or different dimensions on one or both of the horizontal and vertical axes. For processing, the patches of the input data sample 110 may be linearly projected (e.g., projected into a one-dimensional matrix) by a projection block 120 into a linear projection 130. Within this linear projection 130, each patch of the input may be mapped to a positional encoding identifying a location in a multidimensional space in which the visual data lies.

Generally, the transformer encoder 140 includes a multi-head attention block 144 and a multilayer perceptron (MLP) 148. In the multi-head attention block 144, input data (which may be normalized by a normalization block 142 prior to processing by the multi-head attention block 144) may be linearly projected (e.g., multiplied using learned parameters) into three matrices for each head of the multi-head attention block 144: a query matrix Q (also referred to in some aspects as a “query representation” or simply “queries”), a key matrix K (also referred to in some aspects as a “key representation” or simply “keys”), and a value matrix V (also referred to in some aspects as a “value representation” or simply “values”). For example, during training, one or more query weights, key weights, and value weights are learned based on training data, and the queries Q, the keys K, and the values V can be generated by multiplying the input data by the learned weights.

In some aspects, an attention matrix A (also referred to as an “attention map” or simply “attention” in some aspects) is then generated as an output of the transformer encoder 140 based on the queries and keys. For example, the multi-head attention block 144 may compute the dot product of the query matrix and the transposed key matrix (e.g., Q·K^{T}). In some aspects, the multi-head attention block 144 can apply one or more operations (e.g., a row-wise softmax operation) to the dot product to yield the attention matrix A. That is, the attention matrix A generated by the multi-head attention block may be defined as A=σ(Q·K^{T}), where σ corresponds to a regularizing function usable in a transformer neural network, such as a softmax function or the like.

Generally, given an input Xᵢ∈ [symbol] into the i^{th} layer of the vision transformer neural network 100, where L corresponds to the number of tokens (e.g., features of image patches) and D corresponds to a feature dimension, query

$${Q}_{i}^{h} ,$$

key

$${K}_{I}^{h} ,$$

and value

$${V}_{i}^{h}$$

matrices may be calculated for each head h∈{1, . . . , H} in the multi-head attention block 144. Generally,

$${Q}_{i}^{h}$$

=

$${W}_{Q , i}^{h} {X}_{i} ,$$

$${K}_{i}^{h} = {W}_{K , i}^{h} {X}_{i} ,$$

and

$${V}_{i}^{h}$$

=

$${W}_{V , i}^{h} {X}_{i} ,$$

where

$${W}_{Q , i}^{h} ,$$

$${W}_{K , i}^{h} ,$$

and

$${W}_{V , i}^{h}$$

are linear transformation matrices. Subsequently, an attention matrix

$${A}_{i}^{h}$$

for the h^{th} attention head may be calculated based on the equation:

$${A}_{i}^{h} = softmax ( \frac{{{Q}_{i}^{h} ( {K}_{i}^{h} )}^{T}}{√ D} )$$

such that the input into the h^{th} head of the i+1^{th} layer of the vision transformer neural network 100 may be represented by the expression:

$${X}_{i + 1}^{h} = {A}_{i}^{h} \cdot {V}_{i}^{h}$$

The outputs from each of the attention heads h∈{1, . . . , H} may be concatenated and fed into a linear layer to generate the final output of the i^{th} transformer layer according to the expression:

$${X}_{i + 1} = {F}_{i} ( {W}_{O , i} \cdot Concat ( {X}_{i + 1}^{1} , … , {X}_{i + 1}^{H} ) )$$

where Fᵢ represents a function defining the i^{th} attention head and W_{O} corresponds to a linear projection matrix.

The resulting features f generated by the multi-head attention block 144 can then be computed as the dot product of the attention matrix A and the value matrix V. These features f can then be provided as an input (in some aspects, after normalization via a normalization block 146) to the multilayer perceptron 148 (e.g., a neural network or subnet) to generate an output (e.g., attention matrix) from the transformer encoder 140. The output may be used as an input into a subsequent transformer or other block in the neural network or may be the final result of processing an input through the neural network. For example, as illustrated in FIG. 1, the output of the transformer encoder 140 may be provided as an input into a classification head 150 (which may be an MLP head or other head) for processing. The output of the classification head 150 may be a classification 160 of one or more objects in the input data sample 110.

While FIG. 1 illustrates a vision transformer neural network 100 that is configured to classify objects included in the input data sample 110, it should be recognized that the vision transformer neural network 100 may be trained to perform other computer vision tasks, such as depth estimation, motion prediction, or the like, and may include different components appropriate for the execution of such tasks. Further, while FIG. 1 illustrates the use of a multilayer perceptron within the transformer encoder 140 to generate the output of the transformer encoder 140, it should be recognized that any variety of feedforward blocks can be used to generate the output of the transformer encoder 140. Still further, it should be understood that the transformer encoder 140 may utilize any appropriate architecture and that other examples of the transformer encoder 140 may be contemplated.

Generally, within a transformer neural network (e.g., the vision transformer neural network 100), attention may be computed for each token provided as input into the transformer neural network with respect to all other tokens provided as input into the vision transformer neural network. Thus, the computational expense and memory costs involved in processing inputs in a transformer neural network typically scales quadratically with respect to the number of tokens N in the input (e.g., such that the computational and memory costs of processing inputs in a transformer neural network scales according to O(N²)). However, tokens within an input may have different levels of importance to an inferencing process performed by a transformer neural network, such as the vision transformer neural network 100. For example, within an image, different patches (tokens) may carry different information, with inferences being able to be generated quickly (e.g., using a small number of layers of the neural network) for patches with little semantic information (e.g., a patch that depicts the sky) and with inferences being performed using a larger number of layers for patches with large amounts of semantic information (e.g., depicts buildings, vegetation, pavement, and/or other objects which may be relevant for a given task, such as object recognition in autonomous driving applications or the like).

To reduce the computational expense and memory costs involved in processing inputs in a transformer neural network, various techniques can be used to reduce the number of tokens processed by layers within the transformer neural network. In some examples, bipartite matching may be performed on tokens within each layer of the transformer neural network, with the top r matches being retained for processing. In such examples, matching tokens may be merged together and tracked, which may result in each token being processed through each layer of the transformer neural network. Further, because semantically similar tokens are merged, differentiating features in the patches corresponding to these merged tokens may not be learned or detected, and the coarseness of feature maps generated by the transformer neural network may increase with each layer in the neural network.

In other examples, tokens in an input or a feature map may be downsampled to reduce the number of tokens processed by a subsequent layer in the neural network. Generally, tokens may be merged based on spatial proximity, which may allow for merging without the computational complexity involved in bipartite matching. However, because adjacent image patches may not have the same or similar semantic meaning, downsampling techniques may effectively reduce the details and spatial resolution of the feature map, which may have negative downstream effects on the accuracy of inferences generated by the transformer neural network.

In yet other examples, tokens may be scored based on an importance of each token to an ultimate classification task. Based on the scoring, tokens that are of relatively high importance for the classification task may be retained, and tokens that are of relatively low importance for the classification task may be discarded (or downsampled). Thus, the number of tokens processed by a layer of the transformer neural network may decrease with each successive layer of the transformer neural network. However, because information is discarded in each layer of the transformer neural network, scoring-based downsampling techniques may not be recommended for tasks that are more complex than classification; for example, these downsampling techniques may not be recommended for dense prediction tasks such as depth estimation or semantic segmentation.

Certain aspects of the present disclosure provide techniques that leverage the semantic importance of tokens to reduce the computational expense of inferencing tasks in a transformer neural network while allowing for semantic information to be retained throughout the transformer neural network. By doing so, some aspects of the present disclosure may reduce redundant computation by bypassing processing of tokens with less importance to a given task within a layer of the neural network. Further, by joining these bypassed tokens with a feature map generated by the layer of the neural network based on semantically important tokens, certain aspects of the present disclosure may preserve inferencing accuracy.

Example Efficient Inferencing in Transformer Neural Networks with Token Selection

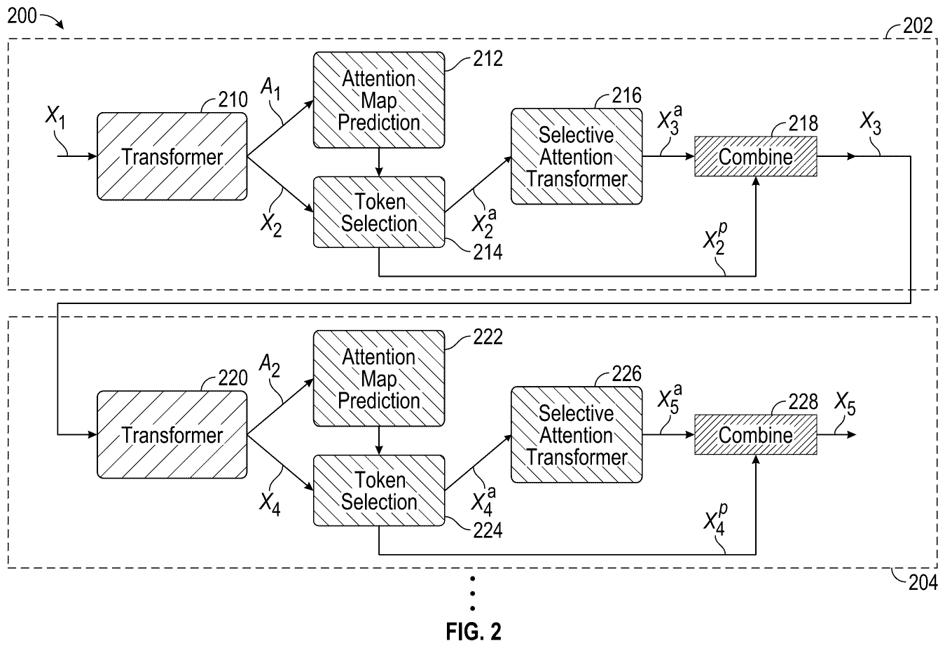

FIG. 2 illustrates an example transformer neural network 200 including layers that selectively process tokens generated by a previous layer in the transformer neural network, according to aspects of the present disclosure.

As illustrated, the transformer neural network 200 includes a plurality of layers which alternate between standard transformer layers and selective token attention layers. Each pair of a standard transformer layer and a selective token attention layer may be organized into a block of layers 202, 204 (amongst others, not illustrated in FIG. 1). In a standard transformer layer, such as the standard transformer layer 210 in the block of layers 202 or the standard transformer layer 220 in the block of layers 204, a tokenized input X₁ may be processed to generate queries Q, keys K, and values V. These matrices Q, K, and V can be generated by multiplying the tokenized input X₁ by the learned weights of the transformer neural network 200, as discussed above with respect to FIG. 1. The resulting output X₂ may represent a feature map associated with the tokenized input X₁ and may include a plurality of tokens.

To reduce the computational expense involved in processing data in a transformer neural network, the output X₂, X₄ of the standard transformer layer 210, 220 may be fed into an attention map prediction block 212, 222 and a token selection block 214, 224 of the blocks of layers 202, 204, respectively, for processing. The attention map prediction block 212, 222 generally includes a predictive model that assigns scores or ranks to tokens (or otherwise prioritizes tokens) in an input into a selective token attention layer (e.g., the selective attention transformer layer 216, 226 of the blocks of layers 202, 204, respectively) in the transformer neural network 200.

The score assigned by the token selection block 214, 224 to each respective token in the output X₂, X₄ of the standard transformer layer 210, 220 (which serves as the input into the selective attention transformer layer of the transformer neural network 200) based on attention map A₁, A₂ generated by the preceding standard transformer layer 210, 220 is generally a score that represents an importance of that respective token to the output of the selective attention transformer layer 216, 226. Based on the score (ranking or other prioritization) assigned to each token in X₂, X₄ by the attention map prediction block 212, 222 based on the corresponding attention map A₁, A₂ generated by the preceding standard transformer layer 210, 220, the token selection block 214, 224 can identify (i) a first subset of tokens in X₂, X₄, respectively, that are more relevant to the output (e.g., feature map) generated by the selective attention transformer layer 216, 226, respectively, and (ii) a second subset of tokens in X₂ (in the block of layers 202) and X₄ (in the block of layers 204) that are less relevant to the output of the selective attention transformer layer 216, 226. The tokens included in the first subset of tokens may include, for example, tokens having a relevance score or other predictive score exceeding a threshold value (which may be learned or defined a priori), the top k tokens in X₂ (in the block of layers 202) and X₄ (in the block of layers 204) (with k being a learned or defined a priori value), or the like. The tokens included in the second subset of tokens may include the tokens in X₂ (in the block of layers 202) and X₄ (in the block of layers 204) not included in the first subset of tokens.

The first subset of tokens, designated

$${X}_{2}^{a}$$

in the block of layers 202 and designated

$${X}_{4}^{a}$$

in the block of layers 204, may also be referred to as a set of “attended tokens.” The second subset of tokens, designated

$${X}_{2}^{p}$$

in the block of layers 202 and designated

$${X}_{4}^{p}$$

in the block of layers 204, may be referred to as a set of “passthrough tokens.” The first subset of tokens

$${X}_{2}^{a} ,$$

$${X}_{4}^{a}$$

may be input into a selective attention transformer layer 216, 226, respectively, for processing to generate an intermediate output

$${X}_{3}^{a} ,$$

$${X}_{5}^{a} ,$$

respectively, including a plurality of output tokens. This intermediate output

$${X}_{3}^{a}$$

for the block of layers 202 and

$${X}_{5}^{a}$$

for the block of layers 204 may be combined with the second subset of tokens

$${X}_{2}^{p} ,$$

$${X}_{4}^{P} ,$$

respectively, to generate output X₃, X₅ of the selective token attention layer 218, 228, respectively. In doing so, X₁, X₂, and X₃ in the block of layers 202 and X₃, X₄, and X₅ in the block of layers 204 may have the same dimensions (e.g., such that any Xₙ∈ [symbol] ), where B represents a batch size, L represents a number of tokens over which attention is calculated, and D represents the dimensionality of the feature vector for each of the L tokens, and thus, each layer in the transformer neural network may generate feature maps based on an input of the same size. That is, while a subset of tokens generated by a standard transformer layer 210, 220 may be processed in the associated selective attention transformer layer 216, 226 in the blocks of layers 202, 204, the next standard transformer layer may still process the passthrough tokens that were not processed in the selective attention transformer layer 216, 226. In doing so, the tokens which were deemed to be of less importance may be discarded in the selective attention transformer layer 216, 226 but may be rejoined for subsequent processing (e.g., by a standard transformer layer in the next block of layers), as such tokens may include information that is of relevance to another layer of the transformer neural network 200. Thus, reductions in inferencing accuracy caused by token downsampling discussed above may be minimized (at least reduced), as aspects of the present disclosure may not discard passthrough tokens permanently so that subsequent layers of the transformer neural network 200 may operate on a full set of data instead of a downsampled set of tokens which discards information from the full set of data.

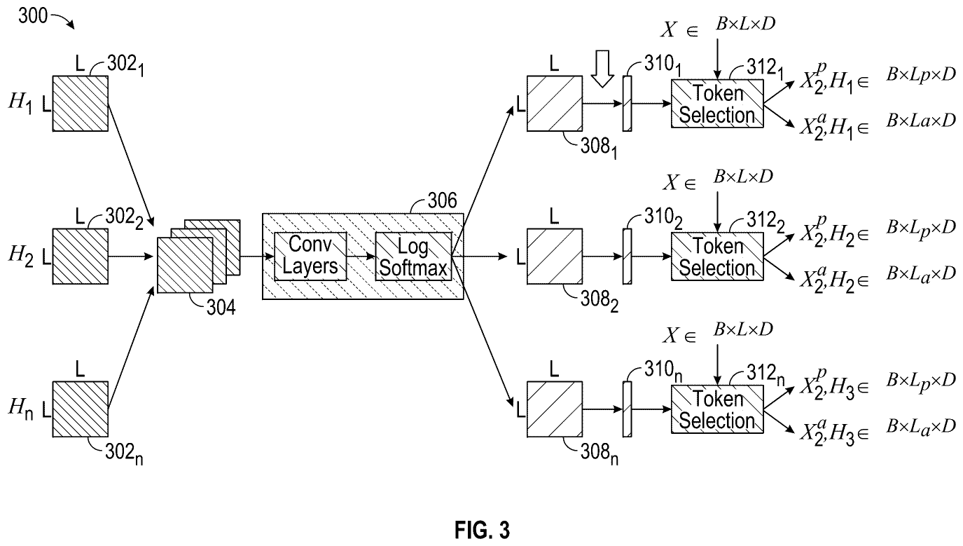

FIG. 3 illustrates a pipeline 300 for efficiently performing inferencing operations in a transformer neural network (e.g., the transformer neural network 200) based on token selection using a predictive model, according to aspects of the present disclosure.

As illustrated, the pipeline 300 includes an i^{th} layer of the transformer neural network (e.g., transformer neural network 200 illustrated in FIG. 2), a predictive model 306, and a token selection module 312₁, 312₂, . . . , 312ₙ (collectively referred to as “token selection modules 312”) for identifying inputs into the i+1¹ layer of the transformer neural network. Generally, the i^{th} layer of the transformer neural network generates a plurality of attention maps 302₁, 302₂, . . . , 302ₙ (collectively referred to as “attention maps 302” and labeled “H₁, H₂, . . . , Hₙ,” respectively), where n corresponds to the number of attention heads included in the i^{th} layer of the transformer neural network. The attention maps 302 may be concatenated into a combined attention map 304 (referred to as “Hᵢ”) for the i^{th} layer of the transformer neural network and input into the predictive model 306 for processing. Generally, each attention map 302 may be a square matrix with dimensions L×L, where L corresponds to the number of tokens included in an input X into a layer in the transformer neural network.

The predictive model 306 may be a machine learning model trained to predict the output of the i+1^{th} layer of the transformer neural network based on the attention maps 302 generated by n heads of the i^{th} layer of the transformer neural network. The predictive model 306 may be, for example, a convolutional neural network including one or more convolutional layers and a nonlinear layer, such as a softmax layer or a log softmax layer, which generates a probability score for each token included in the attention map. Generally, each predicted attention map 308₁, 308₂, . . . , 308ₙ (collectively referred to as “predicted attention maps 308”) may, like the attention maps 302, be a square matrix with dimensions L×L, where L corresponds to the number of tokens included in an input X into a layer in the transformer neural network.

A predictive score (or rank or other prioritization) for each token in a predicted attention map may be generated based on a summation of values over the columns in the predicted attention maps 308 for the i+1^{th} layer of the transformer neural network generated by the predictive model 306 for each attention head in a layer of the transformer neural network. The predictive score for each token may be included in a one-dimensional scoring matrix 310₁, 310₂, . . . , 310ₙ (collectively referred to as “scoring matrices 310”) associated with a corresponding predicted attention map 308, which, as discussed, may be a predicted attention map for a specific attention head in an attention layer of a transformer neural network. For each attention head, the top k tokens based on token scores in the scoring matrix 310 for the respective attention head may be selected at a token selection block 312₁, 312₂, . . . , 312ₙ (collectively referred to as “token selection blocks 312”) for inclusion in the first subset of tokens

$${X}_{2}^{a} ,$$

and the remaining tokens (e.g., L−k tokens) may be included in the second subset of tokens

$${X}_{2}^{p} .$$

Subsequently, the tokens

$${X}_{2}^{a}$$

may be input into a layer of a transformer neural network for processing (e.g., through a selective attention transformer layer 216, 226 illustrated in FIG. 2), and the output of the layer of the transformer neural network may be joined with

$${X}_{2}^{p}$$

to generate an output X₃, as discussed above.

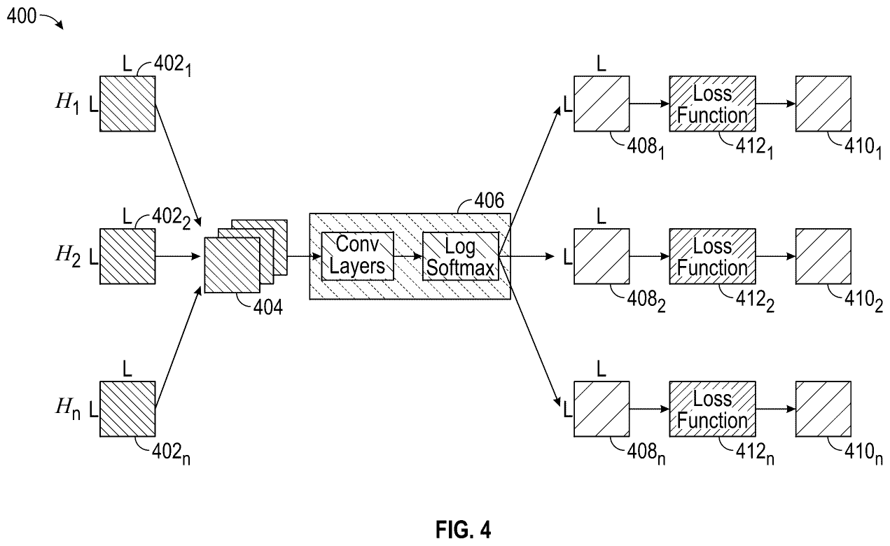

FIG. 4 illustrates a pipeline 400 for training a predictive model 406 to select tokens for selective processing in a transformer neural network (e.g., the transformer neural network 200 illustrated in FIG. 2), according to aspects of the present disclosure.

As illustrated, the predictive model 406 may be trained based on ground-truth attention maps for the i+1^{th} layer of a transformer neural network. To do so, ground-truth attention maps 402₁, 402₂, . . . , 402ₙ (collectively referred to as “ground-truth attention maps 402”) generated in the it layer of the transformer neural network may be mapped to the ground-truth attention maps 410₁, 410₂, . . . , 410ₙ (collectively referred to as “ground-truth attention maps 410”) for the i+1^{th} layer of the transformer neural network. The predictive model 406 may be trained to predict the output of the i+1^{th} layer of the transformer neural network based on the output of the i^{th} layer of the transformer neural network (e.g., the ground-truth attention maps 402 generated by the n heads of the i^{th} layer of the transformer neural network, which may be combined into a concatenated ground-truth attention map 404, as illustrated in FIG. 4). In doing so, the predictive model 406 may be trained to minimize, or at least reduce, a loss between the ground-truth attention map and the predicted attention map for the i+1^{th} layer of the transformer neural network given an input of a specific output of an i^{th} layer of the transformer neural network. In some aspects, the loss function 412₁, 412₂, . . . , 412ₙ (collectively referred to as “loss functions 412”) may be a Kullback-Leibler (KL) divergence loss between the ground-truth attention maps 410 and predicted attention maps 408₁, 408₂, . . . , 408ₙ (collectively referred to as “predicted attention maps 408”) for the i+1^{th} layer of the transformer neural network for a given output of an i^{th} layer of the transformer neural network.

While FIGS. 2 through 4 illustrate the use of a predictive model to predict relevant tokens for an i+₁^{th} transformer layer in a transformer neural network given the output of an i^{th} network, it should be recognized that a transformer neural network may include any number of selective attention transformer layers. FIG. 2, for example, illustrates an architecture in which standard transformer layers and selective transformer layers alternate (e.g., such that even-numbered layers correspond to standard transformer layers and odd-numbered layers correspond to selective attention transformer layers, or vice versa). However, any (non-zero) number of consecutive standard transformer layers may be followed by a selective attention transformer layer, and the selective transformer layer may subsequently be followed by any (non-zero) number of standard transformer layers.

As discussed, the techniques described herein generally provide for significant reductions in computational expense in processing inputs in a transformer neural network. For example, in a case in which 80 percent of tokens from the output of the i^{th} layer of the transformer neural network are provided as input into the i+1^{th} layer of the transformer neural network, the computational expense and memory utilization for the i+1^{th} layer of the transformer neural network may be reduced by 30 percent. Such efficiencies may allow for inferencing operations to be performed in a transformer neural network with significant reductions in the time and computational expense involved in such operations compared with the time and computational expense involved in processing all of the tokens from the output of the i^{th} layer in the i+1^{th} layer of the transformer neural network. Further, the techniques discussed herein may provide for similar inference accuracy as techniques in which token selection is not used to reduce the amount of data processed in a layer of the transformer neural network.

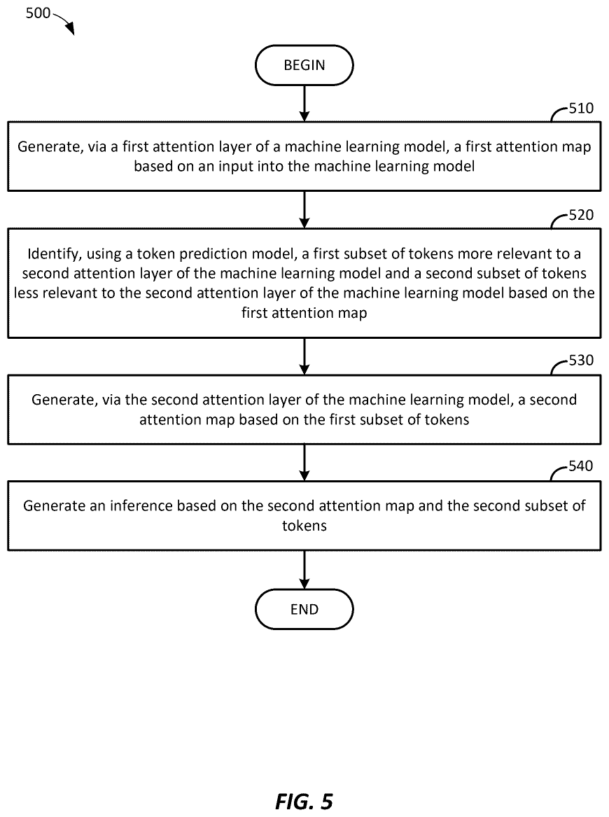

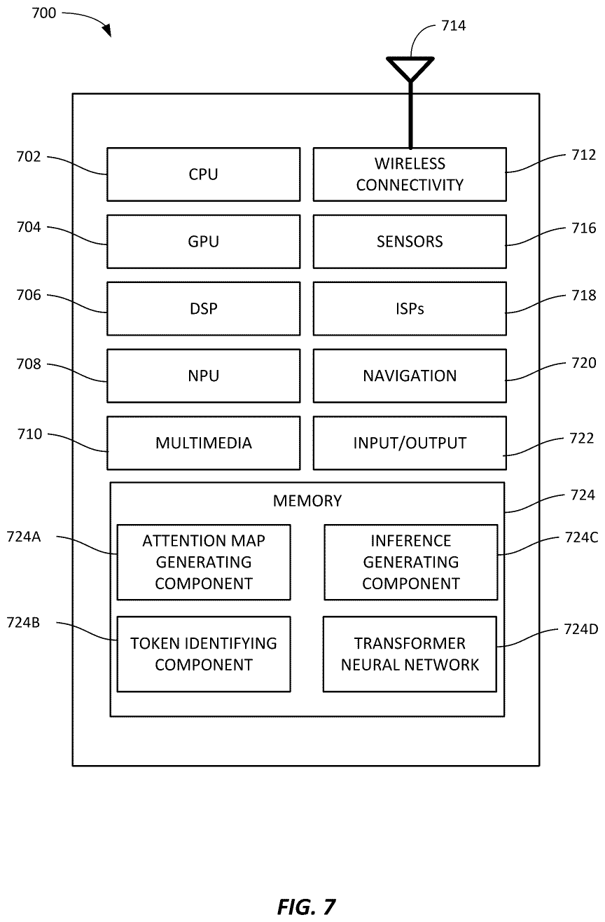

FIG. 5 illustrates example operations 500 for performing inferencing operations in a transformer neural network (e.g., a transformer neural network 200 illustrated in FIG. 2, a token prediction model illustrated in FIG. 3, etc.) based on token selection, according to aspects of the present disclosure. The operations 500 may be performed, for example, by a computing system on which a transformer neural network (e.g., the transformer neural network 200) is deployed for processing nonlinear data, such as a user equipment (UE), a smartphone, a tablet computer, an autonomous vehicle, an edge device, or other computing systems (e.g., such as the processing system 700 illustrated in FIG. 7 and described in further detail below).

As illustrated, the operations 500 begin at block 510 with generating, via a first attention layer of a machine learning model, a first attention map, Aj, based on an input into the machine learning model.

At block 520, the operations 500 proceed with identifying, using a token prediction model (e.g., the predictive model 306 illustrated in FIG. 3), a first subset of tokens and a second subset of tokens based on the first attention map. The first subset of tokens,

$${X}_{i + 1}^{a} ,$$

may be tokens that are more relevant to the output of a second attention layer of the machine learning model (and may be processed by the second attention layer of the machine learning model). The second subset of tokens,

$${X}_{i + 1}^{p} ,$$

may be tokens that are less relevant to the output of the second attention layer (and thus may be bypassed by the second attention layer of the machine learning model).

In some aspects, to identify the first subset of tokens more relevant to the second attention layer of the machine learning model, a relevance score for each token may be calculated based on a prediction of the second attention map generated by the token prediction model. k tokens with highest relevance scores may be selected for inclusion in the first subset of tokens. k may be selected based on an attention ratio defining a percentage of total input tokens to be processed by the second attention layer of the machine learning model.

At block 530, the operations 500 proceed with generating, via the second attention layer of the machine learning model, a second attention map based on the first subset of tokens.

At block 540, the operations 500 proceed with generating an inference based on the second attention map and the second subset of tokens. In some aspects, to do so, the second attention map and the second subset of tokens in the first attention map may be concatenated into a combined attention map. This combined attention map may be input into another layer of the machine learning model for processing. In some aspects, such as when the second attention layer of the machine learning model is the last attention layer of the machine learning model, the combined attention map may be fed into one or more other layers of the machine learning model (e.g., nonlinear layers, such as a softmax layer, a multilayer perceptron, etc.) for use in generating an inference. The inference may include, for example, the identification of objects in visual input data, depth prediction for different objects depicted in visual input data, semantic segmentation of visual input data into different regions corresponding to different classes of objects, or the like.

In some aspects, the operations 500 further include generating, by a prior attention layer of the machine learning model, an attention map based on the input into the machine learning model. An input into the first attention layer of the machine learning model may include the attention map generated by the prior attention layer.

In some aspects, the operations 500 may further include concatenating the second attention map and the second subset of tokens into a concatenated attention map. Using a third attention layer of the machine learning model, a third attention map may be generated based on the concatenated attention map. Using the token prediction model, a third subset of tokens more relevant to a fourth attention layer of the machine learning model and a fourth subset of tokens less relevant to the fourth attention layer of the machine learning model based on the third attention map may be identified. A fourth attention map may be generated via the fourth attention layer of the machine learning model based on the third subset of tokens. The inference may be generated further based on the fourth attention map and the fourth subset of tokens.

In some aspects, the first attention map and the second attention map comprise attention maps for a first attention head in the machine learning model. In some aspects, the token prediction model comprises a model specific to the first attention head. In some aspects, identifying the first subset of tokens and the second subset of tokens comprises predicting relevant tokens based on a concatenation of the attention maps for the first attention head and attention maps for one or more additional attention heads in the machine learning model.

In some aspects, the token prediction model comprises a convolutional model configured to generate a predicted attention map for the second attention layer of the machine learning model based on an input of a first attention map generated by the first attention layer of the machine learning model.

In some aspects, the token prediction model comprises a model configured to generate normalized attention maps for a plurality of attention heads in the machine learning model.

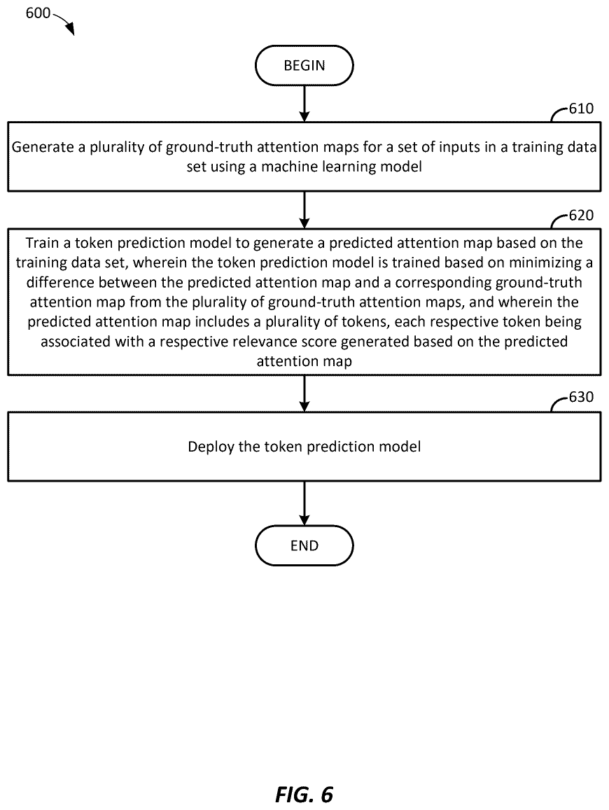

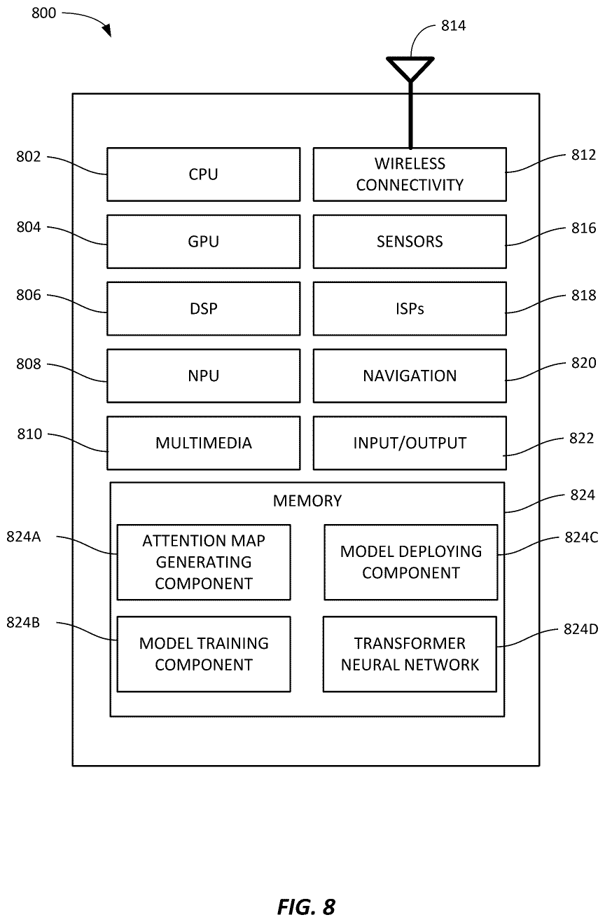

FIG. 6 illustrates example operations 600 for training a predictive model to select tokens for selective processing in a transformer neural network, according to aspects of the present disclosure. The operations 600 may be performed, for example, by a computing system in which one or more machine learning models (e.g., a transformer neural network 200 illustrated in FIG. 2, a token prediction model illustrated in FIG. 3, etc.) can be trained, such as a server computer, a cluster of physical or cloud computing instances, or other computing systems (e.g., such as the processing system 800 illustrated in FIG. 8 and described in further detail below).

The operations 600 begin at block 610 with generating a plurality of ground-truth attention maps for a set of inputs in a training data set using a machine learning model. The plurality of ground-truth attention maps may include attention maps generated by one or more layers in a trained transformer neural network. In some aspects, inputs in the training data set may include a tokenized version of an input into the transformer neural network or attention maps (or feature maps) generated by a layer within the transformer neural network, amongst others.

At block 620, the operations 600 proceed with training a token prediction model to generate a predicted attention map based on the training data set. Generally, the token prediction model may be trained based on minimizing a difference between the predicted attention map and a corresponding ground-truth attention map from the plurality of ground-truth attention maps. The predicted attention map may include a plurality of tokens, with each respective token being associated with a respective relevance score generated based on the predicted attention map.

For example, as discussed, the predicted attention map for which the token prediction model is trained to generate may be an L×L matrix illustrating a relevance of a given token to other tokens in the attention map. This relevance may be defined, for example, as a relevance score generated by a trained softmax function or other nonlinear function that can generate probability values illustrating the relevance of an input to a given output. Because each column in the attention map represents a specific token, a relevance score for each token may be calculated based on a summation of elements within the corresponding column for that token.

In some aspects, training the token prediction model comprises training the token prediction model based on minimizing Kullback-Leibler (KL)-divergence loss between the predicted attention map and the corresponding ground-truth attention map.

At block 630, the operations 600 proceed with deploying the token prediction model.

In some aspects, the token prediction model comprises a convolutional model trained to generate the predicted attention map for a second attention layer of the machine learning model based on an input of a first attention map generated by a first attention layer of the machine learning model.

In some aspects, the token prediction model comprises a model trained to generate normalized attention maps for a plurality of attention heads in the machine learning model.

In some aspects, the machine learning model comprises a frozen transformer neural network.

Example Processing System for Efficient Inferencing in Transformer Neural Networks with Token Selection

FIG. 7 depicts an example processing system 700 configured to perform various aspects of the present disclosure, including, for example, the techniques and methods described with respect to FIGS. 2, 3, and 5. In some aspects, the processing system 700 may execute inferencing operations using a trained transformer-based machine learning model, such as the transformer neural network 200 of FIG. 2. Although depicted as a single system for conceptual clarity, in at least some aspects, as discussed above, the operations described below with respect to the processing system 700 may be distributed across any number of devices.

The processing system 700 includes a central processing unit (CPU) 702, which in some examples may be a multi-core CPU. Instructions executed at the CPU 702 may be loaded, for example, from a program memory associated with the CPU 702 or may be loaded from a partition of memory 724.

The processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation component 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes the memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes an attention map component 724A, a token identifying component 724B, an inference generating component 724C, and a transformer neural network 724D. Though depicted as discrete components for conceptual clarity in FIG. 7, the illustrated components (and others not depicted) may be collectively or individually implemented in various aspects.

Generally, the processing system 700 and/or components thereof may be configured to perform the methods described herein.

Notably, in other aspects, aspects of the processing system 700 may be omitted, such as where the processing system 700 is a server computer or the like. For example, the multimedia processing unit 710, the wireless connectivity component 712, the sensor processing units 716, the ISPs 718, and/or the navigation component 720 may be omitted in other aspects. Further, aspects of the processing system 700 may be distributed between multiple devices.

FIG. 8 depicts an example processing system 800 configured to perform various aspects of the present disclosure, including, for example, the techniques and methods described with respect to FIGS. 4 and 6. In some aspects, the processing system 800 may train, implement, or provide a machine learning model for predicting the relevance of tokens in an output of the i^{th} layer of a transformer neural network to the i+1^{th} layer of the transformer neural network, such as that illustrated in FIG. 4. Although depicted as a single system for conceptual clarity, in at least some aspects, as discussed above, the operations described below with respect to the processing system 800 may be distributed across any number of devices.

The processing system 800 includes a central processing unit (CPU) 802, which in some examples may be a multi-core CPU. Instructions executed at the CPU 802 may be loaded, for example, from a program memory associated with the CPU 802 or may be loaded from a partition of memory 824.

The processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation component 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes the memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes an attention map generating component 824A, a model training component 824B, a model deploying component 824C, and a transformer neural network 824D. Though depicted as discrete components for conceptual clarity in FIG. 8, the illustrated components (and others not depicted) may be collectively or individually implemented in various aspects.

Generally, the processing system 800 and/or components thereof may be configured to perform the methods described herein.

Notably, in other aspects, aspects of the processing system 800 may be omitted, such as where the processing system 800 is a server computer or the like. For example, the multimedia processing unit 810, the wireless connectivity component 812, the sensor processing units 816, the ISPs 818, and/or the navigation component 820 may be omitted in other aspects. Further, aspects of the processing system 800 may be distributed between multiple devices.

### EXAMPLE CLAUSES

Implementation details of various aspects of the present disclosure are described in the following numbered clauses:

Clause 1: A processor-implemented method for machine learning, comprising: generating, via a first attention layer of a machine learning model, a first attention map based on an input into the machine learning model; identifying, using a token prediction model, a first subset of tokens more relevant to a second attention layer of the machine learning model and a second subset of tokens less relevant to the second attention layer of the machine learning model, based on the first attention map; generating, via the second attention layer of the machine learning model, a second attention map based on the first subset of tokens; and generating an inference based on the second attention map and the second subset of tokens.

Clause 2: The method of Clause 1, further comprising generating, by a prior attention layer of the machine learning model, an attention map based on the input into the machine learning model, wherein an input into the first attention layer of the machine learning model comprises the attention map generated by the prior attention layer.

Clause 3: The method of Clause 1 or 2, wherein generating the inference based on the second attention map and the second subset of tokens comprises: concatenating the second attention map and the second subset of tokens into a concatenated attention map; and generating the inference based on the concatenated attention map.

Clause 4: The method of any of Clauses 1 through 3, further comprising: concatenating the second attention map and the second subset of tokens into a concatenated attention map; generating, via a third attention layer of the machine learning model, a third attention map based on the concatenated attention map; identifying, using the token prediction model, a third subset of tokens more relevant to a fourth attention layer of the machine learning model and a fourth subset of tokens less relevant to the fourth attention layer of the machine learning model based on the first attention map; and generating, via the fourth attention layer of the machine learning model, a fourth attention map based on the third subset of tokens, wherein the inference is generated further based on the fourth attention map and the fourth subset of tokens.

Clause 5: The method of any of Clauses 1 through 4, wherein identifying the first subset of tokens more relevant to the second attention layer of the machine learning model comprises: calculating a relevance score of each token based on a prediction of the second attention map generated by the token prediction model; and selecting k tokens with highest relevance scores for inclusion in the first subset of tokens.

Clause 6: The method of Clause 5, wherein k is selected based on an attention ratio defining a percentage of total input tokens to be processed by the second attention layer of the machine learning model.

Clause 7: The method of any of Clauses 1 through 6, wherein the first attention map and the second attention map comprise attention maps for a first attention head in the machine learning model, and wherein the token prediction model comprises a model specific to the first attention head.

Clause 8: The method of Clause 7, wherein identifying the first subset of tokens and the second subset of tokens comprises predicting relevant tokens based on a concatenation of the attention maps for the first attention head and attention maps for one or more additional attention heads in the machine learning model.

Clause 9: The method of any of Clauses 1 through 8, wherein the token prediction model comprises a convolutional model configured to generate a predicted attention map for the second attention layer of the machine learning model based on an input of a first attention map generated by the first attention layer of the machine learning model.

Clause 10: The method of any of Clauses 1 through 9, wherein the token prediction model comprises a model configured to generate normalized attention maps for a plurality of attention heads in the machine learning model.

Clause 11: A processor-implemented method for machine learning, comprising: generating a plurality of ground-truth attention maps for a set of inputs in a training data set using a machine learning model; training a token prediction model to generate a predicted attention map based on the training data set, wherein the token prediction model is trained based on minimizing a difference between the predicted attention map and a corresponding ground-truth attention map from the plurality of ground-truth attention maps, and wherein the predicted attention map includes a plurality of tokens, each respective token being associated with a respective relevance score generated based on the predicted attention map; and deploying the token prediction model.

Clause 12: The method of Clause 11, wherein the token prediction model comprises a convolutional model trained to generate the predicted attention map for a second attention layer of the machine learning model based on an input of a first attention map generated by a first attention layer of the machine learning model.

Clause 13: The method of Clause 11 or 12, wherein the token prediction model comprises a model trained to generate normalized attention maps for a plurality of attention heads in the machine learning model.

Clause 14: The method of any of Clauses 11 through 13, wherein training the token prediction model comprises training the token prediction model based on minimizing Kullback-Leibler (KL)-divergence loss between the predicted attention map and the corresponding ground-truth attention map.

Clause 15: The method of any of Clauses 11 through 14, wherein the machine learning model comprises a frozen transformer neural network.

Clause 16: A processing system comprising: a memory comprising computer-executable instructions; and one or more processors configured to execute the computer-executable instructions and cause the processing system to perform a method in accordance with any of Clauses 1 through 15.

Clause 17: A processing system comprising means for performing a method in accordance with any of Clauses 1 through 15.

Clause 18: A non-transitory computer-readable medium comprising computer-executable instructions that, when executed by one or more processors of a processing system, cause the processing system to perform a method in accordance with any of Clauses 1 through 15.

Clause 19: A computer program product embodied on a computer-readable storage medium comprising code for performing a method in accordance with any of Clauses 1 through 15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
at least one memory having executable instructions stored thereon; and
one or more processors configured to execute the executable instructions in order to cause the processing system to:
generate, via a first attention layer of a machine learning model, a first attention map based on an input into the machine learning model;
identify, using a token prediction model, a first subset of tokens more relevant to a second attention layer of the machine learning model and a second subset of tokens less relevant to the second attention layer of the machine learning model, based on the first attention map;
generate, via the second attention layer of the machine learning model, a second attention map based on the first subset of tokens; and
generate an inference based on the second attention map and the second subset of tokens.

2. The processing system of claim 1, wherein the one or more processors are further configured to generate, by a prior attention layer of the machine learning model, an attention map based on the input into the machine learning model, wherein an input into the first attention layer of the machine learning model comprises the attention map generated by the prior attention layer.

3. The processing system of claim 1, wherein to generate the inference based on the second attention map and the second subset of tokens, the one or more processors are configured to cause the processing system to:
concatenate the second attention map and the second subset of tokens into a concatenated attention map; and
generate the inference based on the concatenated attention map.

4. The processing system of claim 1, wherein the one or more processors are further configured to cause the processing system to:
concatenate the second attention map and the second subset of tokens into a concatenated attention map;
generate, via a third attention layer of the machine learning model, a third attention map based on the concatenated attention map;
identify, using the token prediction model, a third subset of tokens more relevant to a fourth attention layer of the machine learning model and a fourth subset of tokens less relevant to the fourth attention layer of the machine learning model based on the first attention map; and
generate, via the fourth attention layer of the machine learning model, a fourth attention map based on the third subset of tokens, wherein the inference is generated further based on the fourth attention map and the fourth subset of tokens.

5. The processing system of claim 1, wherein to identify the first subset of tokens more relevant to the second attention layer of the machine learning model, the one or more processors are configured to cause the processing system to:
calculate a relevance score of each token based on a prediction of the second attention map generated by the token prediction model; and
select k tokens with highest relevance scores for inclusion in the first subset of tokens.

6. The processing system of claim 5, wherein k is selected based on an attention ratio defining a percentage of total input tokens to be processed by the second attention layer of the machine learning model.

7. The processing system of claim 1, wherein the first attention map and the second attention map comprise attention maps for a first attention head in the machine learning model, and wherein the token prediction model comprises a model specific to the first attention head.

8. The processing system of claim 7, wherein to identify the first subset of tokens and the second subset of tokens, the one or more processors are configured to cause the processing system to predict relevant tokens based on a concatenation of the attention maps for the first attention head and attention maps for one or more additional attention heads in the machine learning model.

9. The processing system of claim 1, wherein the token prediction model comprises a convolutional model configured to generate a predicted attention map for the second attention layer of the machine learning model based on an input of a first attention map generated by the first attention layer of the machine learning model.

10. The processing system of claim 1, wherein the token prediction model comprises a model configured to generate normalized attention maps for a plurality of attention heads in the machine learning model.

11. A processing system for machine learning, comprising:
at least one memory having executable instructions stored thereon; and
one or more processors configured to execute the executable instructions in order to cause the processing system to:
generate a plurality of ground-truth attention maps for a set of inputs in a training data set using a machine learning model;
train a token prediction model to generate a predicted attention map based on the training data set, wherein the token prediction model is trained based on minimizing a difference between the predicted attention map and a corresponding ground-truth attention map from the plurality of ground-truth attention maps, and wherein the predicted attention map includes a plurality of tokens, each respective token being associated with a respective relevance score generated based on the predicted attention map; and
deploy the token prediction model.

12. The processing system of claim 11, wherein the token prediction model comprises a convolutional model trained to generate the predicted attention map for a second attention layer of the machine learning model based on an input of a first attention map generated by a first attention layer of the machine learning model.

13. The processing system of claim 11, wherein the token prediction model comprises a model trained to generate normalized attention maps for a plurality of attention heads in the machine learning model.

14. The processing system of claim 11, wherein to train the token prediction model, the one or more processors are configured to cause the processing system to train the token prediction model based on minimizing Kullback-Leibler (KL)-divergence loss between the predicted attention map and the corresponding ground-truth attention map.

15. The processing system of claim 11, wherein the machine learning model comprises a frozen transformer neural network.

16. A processor-implemented method for machine learning, comprising:
generating, via a first attention layer of a machine learning model, a first attention map based on an input into the machine learning model;
identifying, using a token prediction model, a first subset of tokens more relevant to a second attention layer of the machine learning model and a second subset of tokens less relevant to the second attention layer of the machine learning model, based on the first attention map;
generating, via the second attention layer of the machine learning model, a second attention map based on the first subset of tokens; and
generating an inference based on the second attention map and the second subset of tokens.

17. The method of claim 16, further comprising generating, by a prior attention layer of the machine learning model, an attention map based on the input into the machine learning model, wherein an input into the first attention layer of the machine learning model comprises the attention map generated by the prior attention layer.

18. The method of claim 16, wherein generating the inference based on the second attention map and the second subset of tokens comprises:
concatenating the second attention map and the second subset of tokens into a concatenated attention map; and
generating the inference based on the concatenated attention map.

19. The method of claim 16, further comprising:
concatenating the second attention map and the second subset of tokens into a concatenated attention map;
generating, via a third attention layer of the machine learning model, a third attention map based on the concatenated attention map;
identifying, using the token prediction model, a third subset of tokens more relevant to a fourth attention layer of the machine learning model and a fourth subset of tokens less relevant to the fourth attention layer of the machine learning model based on the first attention map; and
generating, via the fourth attention layer of the machine learning model, a fourth attention map based on the third subset of tokens, wherein the inference is generated further based on the fourth attention map and the fourth subset of tokens.

20. The method of claim 16, wherein identifying the first subset of tokens more relevant to the second attention layer of the machine learning model comprises:
calculating a relevance score of each token based on a prediction of the second attention map generated by the token prediction model; and
selecting k tokens with highest relevance scores for inclusion in the first subset of tokens.

21. The method of claim 20, wherein k is selected based on an attention ratio defining a percentage of total input tokens to be processed by the second attention layer of the machine learning model.

22. The method of claim 16, wherein the first attention map and the second attention map comprise attention maps for a first attention head in the machine learning model.

23. The method of claim 22, wherein identifying the first subset of tokens and the second subset of tokens comprises predicting relevant tokens based on a concatenation of the attention maps for the first attention head and attention maps for one or more additional attention heads in the machine learning model.

24. The method of claim 16, wherein the token prediction model comprises a convolutional model configured to generate a predicted attention map for the second attention layer of the machine learning model based on an input of a first attention map generated by the first attention layer of the machine learning model.

25. The method of claim 16, wherein the token prediction model comprises a model configured to generate normalized attention maps for a plurality of attention heads in the machine learning model.

26. A processor-implemented method for machine learning, comprising:
generating a plurality of ground-truth attention maps for a set of inputs in a training data set using a machine learning model;
training a token prediction model to generate a predicted attention map based on the training data set, wherein the token prediction model is trained based on minimizing a difference between the predicted attention map and a corresponding ground-truth attention map from the plurality of ground-truth attention maps, and wherein the predicted attention map includes a plurality of tokens, each respective token being associated with a respective relevance score generated based on the predicted attention map; and
deploying the token prediction model.

27. The method of claim 26, wherein the token prediction model comprises a convolutional model trained to generate the predicted attention map for a second attention layer of the machine learning model based on an input of a first attention map generated by a first attention layer of the machine learning model.

28. The method of claim 26, wherein the token prediction model comprises a model trained to generate normalized attention maps for a plurality of attention heads in the machine learning model.

29. The method of claim 26, wherein training the token prediction model comprises training the token prediction model based on minimizing Kullback-Leibler (KL)-divergence loss between the predicted attention map and the corresponding ground-truth attention map.

30. The method of claim 26, wherein the machine learning model comprises a frozen transformer neural network.
